(19) United States
(12) Patent Application Publication
(10) Pub. No.: US 2013/0035008 A1
(43) Pub. Date: Feb. 7, 2013

(54) TERMINAL FITTING

(71) Applicant: Masanori Onuma, Makinohara-shi (JP)

(72) Inventor: Masanori Onuma, Makinohara-shi (JP)

(73) Assignee: YAZAKI CORPORATION, Tokyo (JP)

(21) Appl. No.: 13/640,995

(22) PCT Filed: Apr. 12, 2011
(86) PCT No.: PCT/JP2011/059093

§ 371 Date: Oct. 12, 2012

(30) Foreign Application Priority Data
Apr. 13, 2010 (JP) 2010-092097

(51) Int. Cl. H01R 4/10

(52) U.S. Cl. 439/878

(57) ABSTRACT

Disclosed is a terminal fitting that is little affected by thermal shock, and has no reduction in crimping performance on a wire terminal even if the terminal fitting is thin. The terminal fitting is equipped with a draw-formed portion (bead) for reinforcement, extending in an extending direction of side wall portions, on a bottom wall portion of a wire connection portion. With this, bottom wall portion rigidity is improved. Therefore, even if the terminal fitting is thin, it is little affected by thermal shock, and there is no reduction in crimping performance on a wire terminal.

### TECHNICAL FIELD

The invention relates to a terminal fitting that is connected to an electric wire terminal, and particularly, to a terminal fitting to which a core of an electric wire terminal is crimped and connected with being wrapped by the terminal fitting.

### BACKGROUND ART

Patent Document 1 discloses a terminal fitting having an electric wire terminal connected thereto, which is connected to an opposing terminal. The terminal fitting is formed by punching a conductive plate into a predetermined shape with being developed and then bending the same to a terminal shape. The terminal fitting bent into a terminal shape has a connection terminal portion at one side thereof, which is connected to the opposing terminal, and an electric wire connection portion at the other side, to which an electric wire terminal is connected. The electric wire connection portion has a bottom wall portion on which the electric wire terminal is placed and a pair of side wall portions that extends in the same direction from both sides of the bottom wall portion, is bent to wrap the electric wire terminal and thus crimps the electric wire terminal.

When crimping a core of the electric wire terminal with the bottom wall portion and the pair of side wall portions, the bottom wall portion is supported on an anvil, the core is placed on the bottom wall portion and the pair of side wall portions is crimped toward the anvil by a crimper, so that the pair of side wall portions is bent to wrap the core. Thereby, since the bottom wall portion and side wall portions of the electric wire connection portion crimp the core, the electric wire terminal is mechanically connected to the terminal fitting.

### PRIOR ART DOCUMENT

### Patent Documents

Patent Document 1: JP-A-8-213142

### SUMMARY OF INVENTION

### Problems to be Solved by Invention

According to the above terminal fitting, as an electric wire harness to which the terminal fitting is connected is made to be smaller and lighter, it is necessary to reduce a thickness of the plate. When the thickness of the terminal fitting is reduced, the rigidity of the terminal fitting is lowered. Hence, it is not possible to sufficiently obtain the electric wire holding force when the electric wire terminal is crimped to the terminal fitting. Accordingly, there occurs a problem in that the favorable crimping performance (electrical and mechanical performances in the connection) cannot be maintained.

In particular, when the electric wire harness for which the terminal fitting is used is used in environments in which a temperature is largely changed, the crimped portion of the terminal is changed by thermal shock. That is, as shown in FIG. 5, a terminal fitting 50 has a shape shown with the solid line at normal temperatures. However, when the using temperature is gradually increased, the terminal fitting is going to deform outward from a center 52 of a bottom wall portion 51, as shown with arrows 53, and a pair of side wall portions 54, 54 is also going to expand outward, as shown with arrows 55, due to thermal expansion. Therefore, when the terminal fitting 50 repeatedly undergoes the thermal shock of low and high temperatures in environments in which a temperature is largely changed, the terminal fitting 50 repeatedly takes the shapes shown with the solid line and dotted line in FIG. 5. Thereby, the terminal so-called respires, so that an amount of relative deviation of an interface at which the terminal and the core contact each other is increased and a contact resistance is thus unstable.

Therefore, an object of the invention is to provide a terminal fitting that is little affected by thermal shock and has no reduction in crimping performance on an electric wire terminal even if the terminal fitting is thin.

### Means for Solving Problems

In order to achieve the above object, the invention provides a terminal fitting including a connection terminal portion arranged at one side of the terminal fitting, which is connected to an opposing terminal, and an electric wire connection portion arranged at the other side, which is connected to an electric wire terminal, wherein the electric wire connection portion includes a bottom wall portion on which the electric wire terminal is placed and a pair of side wall portions extending from both sides of the bottom wall portion, the pair of side wall portions being bent so as to wrap the electric wire terminal thereby crimping the electric wire terminal, and wherein a draw-formed portion for reinforcement, extending in an extending direction of the side wall portions is provided on at least the bottom wall portion of the electric wire connection portion.

Also, preferably, the draw-formed portion is a bead protruding and being press-formed into a strip shape from an outer periphery of the bottom wall portion toward an inner periphery of the bottom wall portion.

Also, preferably, the draw-formed portion is provided at both end sides of the bottom wall portion in a longitudinal direction of the electric wire terminal.

Also, preferably, at least one draw-formed portion is provided at a central portion of the bottom wall portion in a longitudinal direction of the electric wire terminal.

### Advantageous Effects of Invention

According to the invention, at least the bottom wall portion of the electric wire connection portion is provided with the draw-formed portion for reinforcement extending in the developing direction of the side wall portions. Thereby, it is possible to maintain the rigidity even when the terminal fitting is thin, thereby suppressing the crimping performance on the electric wire terminal from being lowered. As a result, the fixing strength between the electric wire terminal and the terminal fitting is improved.

Also, even when the terminal fitting is applied with the thermal shock at the state where the electric wire terminal is wrapped and crimped by the bottom wall portion and the pair of side wall portions, since the bottom wall portion is provided with the bead for reinforcement to thus improve the rigidity, the deformation of the bottom wall portion and the pair of side wall portions is suppressed. Thereby, since the so-called respiration behavior of the bottom wall portion and the pair of side wall portions during the thermal shock is reduced, an amount of relative deviation of the terminal fitting and the electric wire terminal is reduced, so that the contact resistance after the thermal shock becomes stable.

### BRIEF DESCRIPTION OF DRAWINGS

FIG. 1 is a plan view showing a part of a horizontal chain type terminal, which shows a state where a developed terminal fitting and a bent terminal fitting are connected to a chain strap.

FIGS. 2A to 2C show a part of an electric wire connection portion of the terminal fitting, in which FIG. 2A shows a case where one bead is provided, FIG. 2B shows a case where two beads are provided and FIG. 2C shows a case where three beads are provided.

FIGS. 3A and 3B show a bottom wall portion and a pair of side wall portions of the terminal fitting before a core is crimped, in which FIG. 3A shows a case where the bottom wall portion has an arc shape and FIG. 3B shows a case where the bottom wall portion has a planar shape.

FIG. 4 is a sectional view showing the bottom wall portion and the pair of side wall portions of the terminal fitting at a state where the core is crimped.

FIG. 5 is a sectional view showing a bottom wall portion and a pair of side wall portions of a terminal fitting at a state where a core is crimped, which shows a behavior when thermal shock is applied.

### EMBODIMENTS OF INVENTION

Hereinafter, illustrative embodiments of the invention will be described with reference to the drawings.

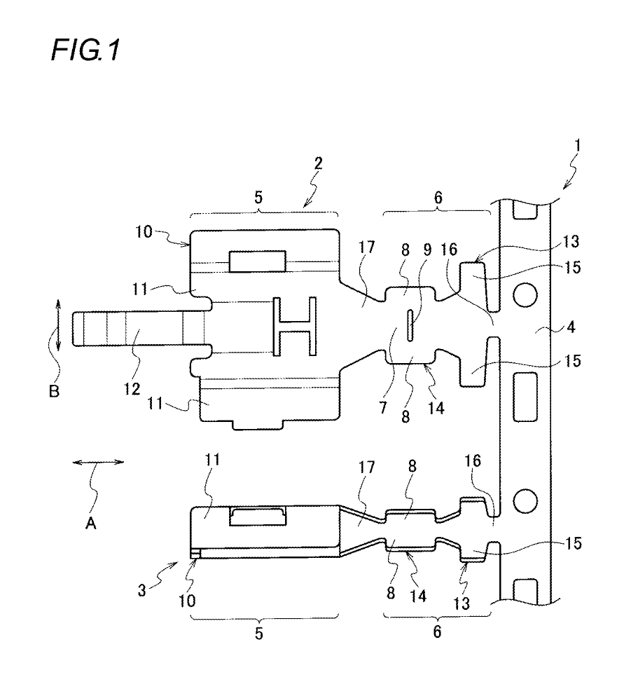

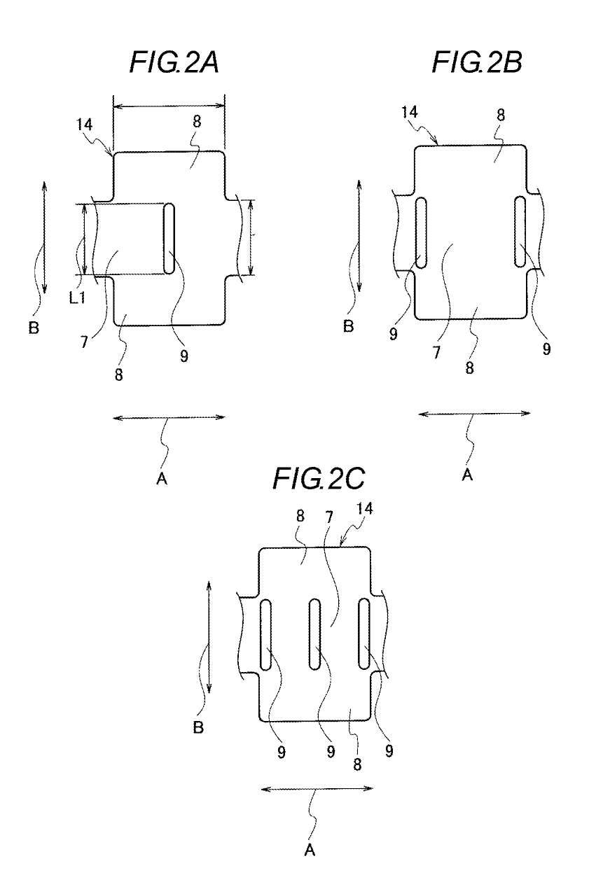

FIG. 1 shows a part of a horizontal chain type terminal 1. In FIG. 1, it is shown that a terminal fitting 2, which is formed by punching a conductive plate into a predetermined shape with being developed, and a terminal fitting 3, which is completed by bending the developed terminal fitting 2, are connected to a chain strap 4. In the below descriptions, the completed terminal fitting 3 is described. Also, the developed terminal fitting 2 is described, as required. Meanwhile, in FIGS. 2A and 2B, a direction indicated by a reference numeral A is indicative of a longitudinal direction (hereinafter, referred to as ‘longitudinal direction of a terminal’) of the terminal fitting along a longitudinal direction of a connected electric wire, and a direction indicated by a reference numeral B is indicative of a developing direction (hereinafter, referred to as ‘developing direction’ of a pair of side walls that will be described later) of the developed terminal fitting 2.

As shown in FIG. 1, the terminal fitting 3 to which the invention is applied is formed by punching a conductive plate into a predetermined shape with being developed and then bending the same and has a connection terminal portion 5 at one side thereof, which is connected to an opposing terminal, and an electric wire connection portion 6 at the other side, to which an electric wire terminal (not shown) is connected. The electric wire connection portion 6 has a bottom wall portion 7 on which the electric wire terminal is placed and a pair of side wall portions 8, 8 that extends and develops from both sides of the bottom wall portion 7, is bent to wrap the electric wire terminal and thus crimps the electric wire terminal.

In this illustrative embodiment, the terminal fitting 3 is provided with a bead 9 serving as a draw-formed portion for reinforcement extending in the developing direction of the pair of side wall portions 8, 8, on at least the bottom wall portion 7 of the electric wire connection portion 6.

In the below, the respective portions of the terminal fitting 3 are described.

As shown in the developed terminal fitting 2, the connection terminal portion 5 is provided with a cylindrical piece 11 along the longitudinal direction of the terminal, which forms a cylindrical portion 10 into which the opposing terminal is inserted. An elastic piece 12 extends in the longitudinal direction from a central portion of the cylindrical piece 11 with respect to the developing direction thereof. The cylindrical piece 11 is bent into a rectangular cylinder shape to thus form the cylindrical portion 10, and the elastic piece 12 is overlapped in the cylindrical portion 10. The electric wire connection portion 6 continuing from the connection terminal portion 5 is formed at the chain strap 4-side.

The electric wire connection portion 6 has an electric wire holding portion 13 to which a core of the electric wire terminal and an insulating cover provided around the core are together crimped and a core connection portion 14 to which only the core of the electric wire terminal is crimped and electrically connected. The electric wire holding portion 13 is provided with electric wire holding pieces 15 extending toward both sides of the developing direction, and has one side in the longitudinal direction, which is integrally connected to the chain strap 4 via a connection portion 16, and the other side at which the core connection portion 14 is formed via a connection portion 17.

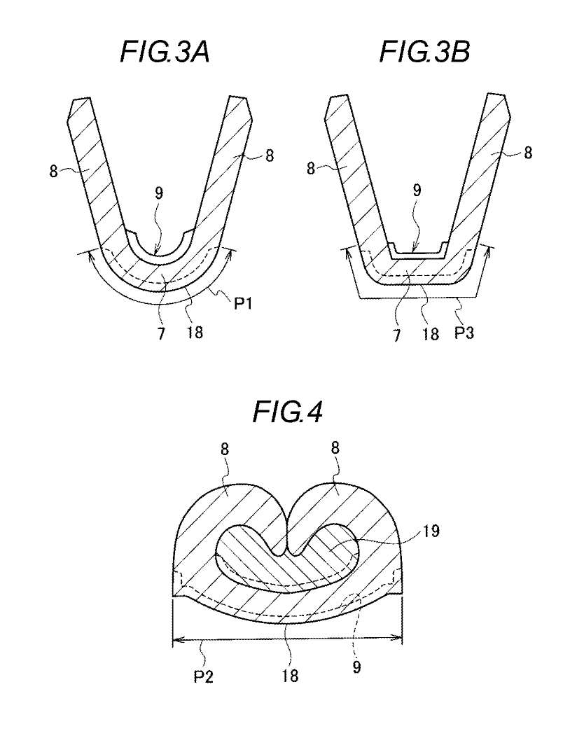

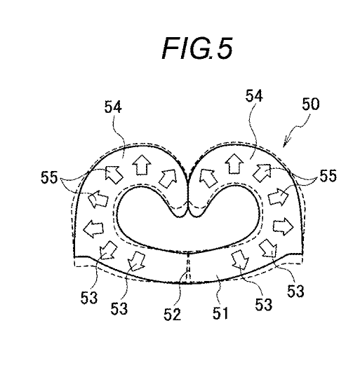

The core connection portion 14 has the bottom wall portion 7 continuing from the electric wire holding portion 13 to the connection terminal portion 5 and the pair of side wall portion 8, 8 extending from both sides of the bottom wall portion 7 in the developing direction. The bottom wall portion 7 is provided with the bead 9 for reinforcement at a central portion of the longitudinal direction A (a central portion of a direction intersecting with the developing direction B of the side wall portions 8, 8), which bead extends in the developing direction. The bead 9 protrudes into a strip shape and is press-formed from an outer periphery 18 of the bottom wall portion 7 toward inner peripheries of the pair of side wall portions 9 (i.e., an inner periphery of the bottom wall portion 7). Also, as shown in FIG. 2A, regarding the developed terminal fitting 2, a length L1 of the bead 9 in the developing direction is slightly longer than a length L2 of the bottom wall portion 7 in the developing direction. As shown in FIG. 3A, at least at a state where the bottom wall portion 7 is bent into an arc shape and the pair of side wall portions 8, 8 is bent into a U shape, the bead 9 is formed within a range P1 including all outer periphery of the bottom wall portion 7 in the developing direction. Also, as shown in FIG. 4, at a state where the core 19 of the electric wire terminal is crimped, the bead 9 is provided within a range P2 including all outer periphery of the bottom wall portion 7 in the developing direction. Also, as shown in FIG. 3B, when the bottom wall portion 7 is bent into a planar shape, the bead 9 is formed within a range P3 including all outer periphery of the bottom wall portion 7 in the developing direction at a state where the pair of side wall portions 8, 8 is bent into a U shape. Also in this case, the bead 9 is provided within the range P2 including all outer periphery of the bottom wall portion 7 in the developing direction at a state where the core 19 of the electric wire terminal is crimped, as shown in FIG. 4.

Also, as shown in FIG. 2B, the bead 9 may be respectively provided at both sides of the bottom wall portion 7 in a direction intersecting with the longitudinal direction of the electric wire terminal, i.e., in the longitudinal direction A. In this case, the rigidity of the bottom wall portion 7 is improved, compared to the configuration where the one bead 9 is provided at the central portion of the bottom wall portion 7 in the longitudinal direction A.

Also, as shown in FIG. 2C, the beads 9 may be provided at three locations along the longitudinal direction A of the bottom wall portion 7 by combining the position shown in FIG. 2A and the positions shown in FIG. 2B. In this case, the rigidity of the bottom wall portion 7 is further improved, compared to the configuration where the beads 9 are provided at the two positions shown in FIG. 2B.

In the respective illustrative embodiments, the bead 9 is a draw-formed bead for improving the rigidity of the bottom wall portion 7 and is formed by performing drawing processing of enabling the bead to protrude from the outer periphery 18 of the bottom wall portion 7 in a line shape (strip shape) toward the inner sides of the pair of side wall portions 8, 8 by a press.

In the respective illustrative embodiments, the bead is provided to protrude from the outer periphery 18 of the bottom wall portion 7 toward the pair of side wall portions 8, 8 (i.e., toward the inner periphery of the bottom wall portion 7) by the press. However, the bead may be formed by performing the drawing processing of enabling the bead to protrude from the inner peripheries of the pair of side wall portions 8, 8 in a line shape toward the outer periphery 18.

According to the above illustrative embodiments, the bead 9 for reinforcement extending in the developing direction B of the side wall portions 8, 8 is provided on at least the bottom wall portion 7 of the electric wire connection portion 6, so that the rigidity can be maintained even if the terminal fitting 3 is thin. Thereby, since it is possible to suppress the crimping performance on the electric wire terminal from being lowered, the fixing strength between the electric wire terminal and the terminal fitting 3 is improved.

The bottom wall portion 7 is provided with the bead 9, as described above. Thus, even when the terminal fitting is going to deform from the center 52 of the bottom wall portion 7 in the direction shown with the arrows 53, due to the thermal expansion, the rigidity of the bottom wall portion 7 is improved by the bead 9 and both sides of the center 52 are not thus deformed as shown with the dotted line. Accordingly, the terminal fitting is not deformed in an outward opening direction from the state where the side wall portions extending from the bottom wall portion 7 is crimped to wrap the core.

Also, even when the terminal fitting is applied with the thermal shock at the state where the electric wire terminal is wrapped and crimped by the bottom wall portion 7 and the pair of side wall portions 8, 8, since the bottom wall portion 7 is provided with the bead 9 for reinforcement to thus improve the rigidity, the repeating deformation of the bottom wall portion 7 and the pair of side wall portions 8, 8, is suppressed. Thereby, since the so-called respiration behavior of the bottom wall portion 7 and the pair of side wall portions 8, 8 during the thermal shock is reduced, an amount of relative deviation of the terminal fitting and the electric wire terminal is reduced, so that the contact resistance after the thermal shock becomes stable.

Meanwhile, in the illustrative embodiment, the thermal shock indicates a phenomenon that an object is applied with shocking thermal stress due to the severe temperature change and means that when the thermal expansion/contraction is restrained in abnormal temperature conditions, the thermal stress occurs depending on a degree of the restraint and an elastic coefficient of the object. The terminal fitting 3 of the illustrative embodiment is also used in environments in which the temperature is severely changed and is thus applied with the thermal shock.

Meanwhile, in the above illustrative embodiments, the bead 9 is formed along the developing direction B. However, the bead may be slightly inclined relative to the developing direction B or the bead 9 may have any shape, other than the linear shape.

Although the invention has been specifically described with reference to the specific illustrative embodiments, it is obvious to one skilled in the art that a variety of changed and modifications can be made without departing from the spirit and scope of the invention.

This application is based on Japanese Patent Application No. 2010-092097 filed on Apr. 13, 2010, the disclosures of which are incorporated herein by reference.

### INDUSTRIAL APPLICABILITY

According to the terminal fitting of the invention, at least the bottom wall portion of the electric wire connection portion is provided with the draw-formed portion for reinforcement extending in the developing direction of the side wall portions. Thereby, it is possible to maintain the rigidity even when the terminal fitting is thin, thereby suppressing the crimping performance on the electric wire terminal from being lowered. As a result, the fixing strength between the electric wire terminal and the terminal fitting is improved.

### DESCRIPTION OF REFERENCE NUMERALS

3: terminal fitting

5: connection terminal portion

6: electric wire connection portion

9: bead (draw-formed portion)

18: outer periphery

1. A terminal fitting comprising:
a connection terminal portion arranged at one side of the terminal fitting, which is connected to an opposing terminal, and
an electric wire connection portion arranged at the other side of the terminal fitting, which is connected to an electric wire terminal,
wherein the electric wire connection portion includes a bottom wall portion on which the electric wire terminal is placed and a pair of side wall portions extending from both sides of the bottom wall portion, the pair of side wall portions being bent so as to wrap the electric wire terminal thereby crimping the electric wire terminal, and
wherein a draw-formed portion for reinforcement, extending in an extending direction of the side wall portions is provided on at least the bottom wall portion of the electric wire connection portion.

2. The terminal fitting according to claim 1, wherein the draw-formed portion is a bead protruding and being press-formed into a strip shape from an outer periphery of the bottom wall portion toward an inner periphery of the bottom wall portion.

3. The terminal fitting according to claim 1, wherein the draw-formed portion is provided at both end sides of the bottom wall portion in a longitudinal direction of the electric wire terminal.

4. The terminal fitting according to claim 1, wherein at least one draw-formed portion is provided at a central portion of the bottom wall portion in a longitudinal direction of the electric wire terminal.
